(19) United States
(12) Patent Application Publication
(10) Pub. No.: US 2022/0278443 A1
(43) Pub. Date: Sep. 1, 2022

(54) ROOF PANEL MODULE AND ROOF MODULE

(71) Applicants: AutoNetworks Technologies, Ltd., Mie (JP); Sumitomo Wiring Systems, Ltd., Mie (JP); SUMITOMO ELECTRIC INDUSTRIES, LTD., Osaka (JP)

(72) Inventors: Yuji TAKENAKA, Mie (JP); Norichika OOMI, Mie (JP); Kosuke SONE, Mie (JP); Suguru YAMAGISHI, Osaka (JP); Takanori FUKUNAGA, Osaka (JP)

(73) Assignees: AutoNetworks Technologies, Ltd., Mie (JP); Sumitomo Wiring Systems, Ltd., Mie (JP); SUMITOMO ELECTRIC INDUSTRIES, LTD., Osaka (JP)

(21) Appl. No.: 17/624,661

(22) PCT Filed: Jun. 23, 2020
(86) PCT No.: PCT/JP2020/024587

§ 371 Date: Jan. 4, 2022

(30) Foreign Application Priority Data
Jul. 11, 2019 (JP) 2019-129497

(51) Int. Cl. H01Q 1/32; H01Q 1/52; B62D 29/04; B62D 25/06

(52) U.S. Cl. CPC H01Q 1/3275; H01Q 1/52; B62D 29/043; B62D 25/06

(57) ABSTRACT

A roof panel module includes: a vehicle roof panel formed by resin; a radio wave shielding part provided in a corresponding region of the vehicle roof panel; and a conductive elastic member having conductivity, wherein the conductive elastic member is provided along at least a part of an edge of the vehicle roof panel.

### TECHNICAL FIELD

The present disclosure relates to a roof panel module and roof module.

### BACKGROUND ART

Patent Document 1 discloses a roof module including an antenna and a metal panel. The antenna is provided on an inner side of a vehicle interior of a roof panel formed into a planar shape by a resin material to constitute an exterior of a vehicle. The metal panel is provided on an inner side of a vehicle interior of the antenna.

### PRIOR ART DOCUMENTS

### Patent Documents

Patent Document 1: Japanese Patent Application Laid-Open No. 2017-200086

### SUMMARY

### Problem to be Solved by the Invention

Desired is a further improvement of a communication environment in a vehicle in a case of applying a resin roof panel. An edge of the resin roof panel is combined with the other part. Desired is that a waterproof property is increased and a radio wave leakage is suppressed in a region near the edge thereof.

An object of the present disclosure is to increase a waterproof property and suppress a radio wave leakage in a region near an edge of a resin roof panel while improving a communication environment in a vehicle.

### Means to Solve the Problem

A roof panel module according to the present disclosure includes: a vehicle roof panel formed by resin; a radio wave shielding part provided in a corresponding region of the vehicle roof panel; and a conductive elastic member having conductivity, wherein the conductive elastic member is provided along at least a part of an edge of the vehicle roof panel.

A roof module according to the present disclosure includes: a radio wave shielding part provided in a corresponding region of a vehicle roof panel formed by resin; an external antenna module; and a conductive elastic member having conductivity, wherein an opening is formed in the radio wave shielding part, the external antenna module is fitted into the opening, and the conductive elastic member is provided along an edge of the opening.

### Effects of the Invention

According to the present disclosure, a waterproof property is increased and a radio wave leakage is suppressed in a region near an edge of a resin roof panel while a communication environment in a vehicle is improved.

### BRIEF DESCRIPTION OF DRAWINGS

FIG. 1 is a schematic perspective view illustrating a vehicle into which a roof panel module according to an embodiment 1 is incorporated.

FIG. 2 is a cross-sectional view of a roof panel module.

FIG. 3 is a partial plan view of a roof panel module.

FIG. 4 is an exploded perspective view illustrating a roof module.

FIG. 5 is a cross-sectional view illustrating a roof module.

### DESCRIPTION OF EMBODIMENT(S)

### Description of Embodiment of Present Disclosure

Embodiments of the present disclosure are listed and described firstly.

A roof panel module according to the present disclosure is as follows.

(1) A roof panel module includes: a vehicle roof panel formed by resin; a radio wave shielding part provided in a corresponding region of the vehicle roof panel; and a conductive elastic member having conductivity, wherein the conductive elastic member is provided along at least a part of an edge of the vehicle roof panel. The radio wave shielding part can shield radio wave by the vehicle roof panel. Thus, a communication environment in the vehicle can be improved. A waterproof property is increased by the conductive elastic member in the region near the edge of the vehicle roof panel. A radio wave leakage is suppressed by the conductive elastic member. Herein, the radio wave shielding part is a part shielding radio wave in at least a part of a frequency band.

(2) The radio wave shielding part may be a frequency selection part having a selective radio wave shielding property with regard to a frequency band. Radio wave in a part of the frequency band is shielded by the roof panel module, and radio wave in the other part of the frequency band can pass through the roof panel module. Thus, a communication environment in the vehicle can be improved.

(3) The roof panel module may further include an external antenna module, wherein the external antenna module is fitted into an opening formed in the vehicle roof panel, and the conductive elastic member is provided along an edge of the opening. A waterproof property is increased and a radio wave leakage is suppressed by the conductive elastic member between the opening of the vehicle roof panel and the external antenna module.

(4) The conductive elastic member may be provided along at least a part of an outer peripheral edge of the vehicle roof panel. A waterproof property is increased and a radio wave leakage is suppressed by the conductive elastic member in the region near the outer peripheral edge of the vehicle roof panel.

A roof module according to the present disclosure is as follows.

(5) A roof module includes: a radio wave shielding part provided in a corresponding region of a vehicle roof panel formed by resin; an external antenna module; and a conductive elastic member having conductivity, wherein an opening is formed in the radio wave shielding part, the external antenna module is fitted into the opening, and the conductive elastic member is provided along an edge of the opening. A waterproof property is increased and a radio wave leakage is suppressed in a region near an edge of a resin roof panel while a communication environment in a vehicle is improved.

### Details of Embodiment of Present Disclosure

Specific examples of a roof panel module and roof module of the present disclosure are described hereinafter with reference to the drawings. The present disclosure is not limited to these examples, but is indicated by claims, and it is intended that meanings equivalent to claims and all modifications within a scope of claims are included.

### Embodiment 1

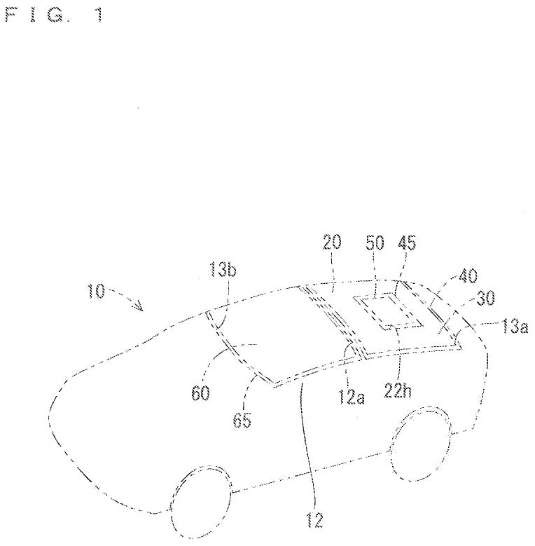

A roof panel module according to an embodiment 1 is described hereinafter. FIG. 1 is a schematic perspective view illustrating a vehicle 10 into which roof panel modules 20 and 60 are incorporated. The vehicle 10 includes a body 12. The body 12 is a part forming an outline of the vehicle 10. The body 12 may be a monocoque body or a body mounted on a ladder type frame. The body 12 may be formed by metal or resin. The body 12 is formed by a metal plate herein. The body 12 itself can shield radio wave. An opening is formed on an upper side of a vehicle interior in the body 12. An reinforcement bar 12a is provided across an intermediate portion of the opening in a front-back direction. In the present specification, the front-back direction is a front-back direction with respect to the vehicle 10, thus a forward traveling direction of the vehicle 10 is a front side, and a backward traveling direction thereof is a back side. A right-left direction is based on a state of being directed to the front side of the vehicle 10. The right-left direction is also a width direction. An up-down direction is an up-down direction with respect to the vehicle 10. The opening is divided into a plurality of (two herein) openings 13a and 13b by the reinforcement bar 12a. Herein, the openings 13a and 13b are openings each having a quadrangular shape. The roof panel module 20 is fitted into the opening 13a. The roof panel module 60 is fitted into the opening 13b. It is also applicable that one opening is formed in the body 12 and one roof panel module is fitted into the opening.

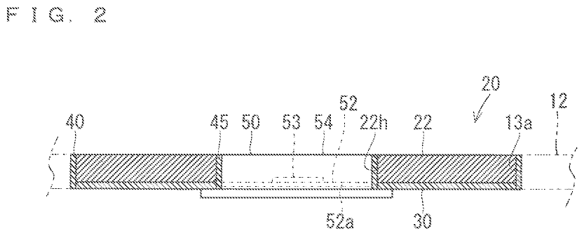

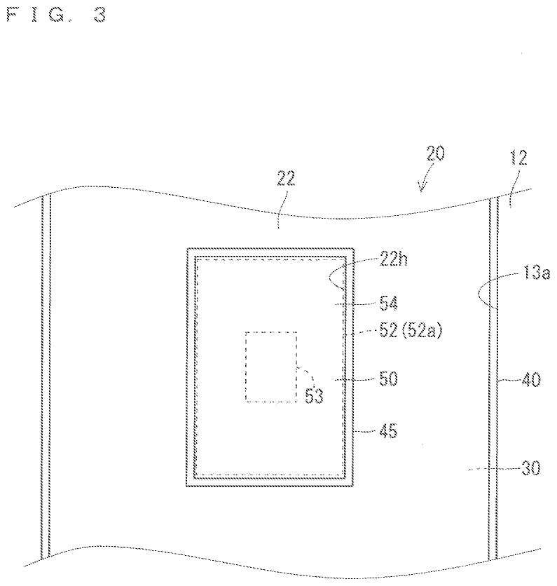

FIG. 2 is a cross-sectional view of the roof panel module 20. FIG. 3 is a partial plan view of the roof panel module 20.

The roof panel module 20 includes a vehicle roof panel 22, a radio wave shielding part 30, and conductive elastic members 40 and 45.

The vehicle roof panel 22 is formed of resin. The formation of the vehicle roof panel 22 by the resin contributes to weight saving of the vehicle 10. Herein, the vehicle roof panel 22 is formed into a quadrangular plate-like shape capable of covering the opening 13a. It is not necessary to form the vehicle roof panel 22 into a quadrangular shape, however, the shape thereof can be appropriately set in accordance with the shape of the opening 13a, for example. The vehicle roof panel 22 may be locally or partially curved to form an appearance shape of the vehicle 10. Herein, an antenna opening 22h is formed in the vehicle roof panel 22. Herein, the antenna opening 22h is formed in a midway portion of the vehicle roof panel 22 in a width direction and the front-back direction. The antenna opening 22h may be formed in a position closer to one lateral side, the front side, or the back side in the vehicle roof panel 22.

The vehicle roof panel 22 in a state of being fitted into the opening 3a is fixed to the body 12 by a screw or a fitting structure, for example. In this state, the vehicle roof panel 22 is exposed to an upper side of the vehicle 10.

The radio wave shielding part 30 is provided in a corresponding region of the vehicle roof panel 22. The radio wave shielding part 30 is provided to extend to a whole lower surface of the vehicle roof panel 22 herein. The radio wave shielding part may be larger or smaller than the vehicle roof panel. For example, an edge of the radio wave shielding part may protrude or get into the edge thereof within a range of 5 cm from an edge of the vehicle roof panel. When the radio wave shielding part is smaller than the vehicle roof panel, the conductive elastic member is preferably provided to protrude to a side of the vehicle roof panel and have contact with the radio wave shielding part. When the radio wave shielding part is larger than the vehicle roof panel, a part of the radio wave shielding part protruding from the vehicle roof panel may be folded.

The radio wave shielding part 30 is a part planarly extending to suppress a radio wave transmission between one main surface and the other main surface of the radio wave shielding part 30. The radio wave shielding part 30 may have a radio wave shielding property on all of frequencies or may also have a selective radio wave shielding property on a frequency band. In this case, it is sufficient that at least one of reflection and absorption of radio wave of some frequency band is performed in the radio wave shielding part 30. The radio wave shielding part 30 may be a part formed of metal such as aluminum or iron. A known frequency selective surface (FSS) may be used as the radio wave shielding part 30 having the selective radio wave shielding property. The frequency selective surface has a configuration that a unit cell (element) is formed by a metal foil on a base film formed of resin, for example. Such a frequency selective surface has characteristics of selectively shielding radio wave of one or a plurality of frequency bands in accordance with frequency characteristics of the unit cell (element), and passing radio wave of the other frequency band. The radio wave shielding part having the selective radio wave shielding property may also be formed by directly printing a conductive paste on an inner surface of the vehicle roof panel 22, for example.

When the radio wave shielding part 30 has the selective radio wave shielding property, an example of a shielded frequency band is as follows.

An example of the shielded frequency band is a frequency band of the radio wave for a plurality of apparatuses (a smartphone, a mobile, phone, a personal computer apparatus, for example) provided in a vehicle interior side of the radio wave shielding part to perform communication with each other. For example, a frequency band for a Wi-Fi (registered trademark) communication or a Bluetooth (registered trademark) communication is an example of the shielded frequency band. Accordingly, the radio wave for the apparatus on the inner side of the vehicle to perform a wireless communication is shielded by the radio wave shielding part 30, and is hardly transmitted to a vehicle exterior side.

Another example of the shielded frequency band is a frequency band of radio wave (electrical power) used for an interior apparatus to have a non-contact power supply on a vehicle interior side of the radio wave shielding part 30. Accordingly, the radio wave (electrical power) is not leaked to an outer side of the vehicle, thus the non-contact power supply is efficiently performed.

Another example of the shielded frequency band is a frequency of radio wave for an external antenna module 50 described hereinafter to perform a wireless communication with an external apparatus (a base station, for example). Accordingly, the radio wave radiated from an external antenna 53 of the external antenna module 50 is shielded by the radio wave shielding part 30, and is hardly transmitted to the inner side of the vehicle. The radio wave radiated from the external antenna 53 is not shielded by the radio wave shielding part 30, but is transmitted to the outer side. Thus, the wireless communication with an external apparatus (a base station, for example) via the external antenna 53 is favorably performed.

When the radio wave shielding part 30 has the selective radio wave shielding property, an example of a frequency band not to be shielded is as follows.

The example of the frequency band not to be shielded is a frequency band of radio wave used in a public communication line or a private communication line in a case where an interior apparatus such as a smartphone performs a wireless communication with an external apparatus via the public communication line or the private communication line. When the frequency band of the radio wave is out of the frequency band shielded by the radio wave shielding part 30, an apparatus in the vehicle can favorably perform the wireless communication with a communication apparatus (a base station, for example) on the outer side of the vehicle.

The conductive elastic members 40 and 45 are members each having conductivity and elasticity. For example, each of the conductive elastic members 40 and is a rubber including a conductive filler such as a conductive carbon or a metal powder. The conductive elastic members 40 and 45 are provided along at least a part of an edge of the vehicle roof panel 22. Herein, the edge of the vehicle roof panel 22 indicates a part observable as a boundary of the vehicle roof panel 22 in a plan view regardless of an outer side and an inner side of the vehicle roof panel 22.

The conductive elastic member 40 is provided along at least a part of an outer peripheral edge of the vehicle roof panel 22. Herein, the conductive elastic member 40 is provided between the whole outer peripheral edge of the vehicle roof panel 22 and a whole inner peripheral edge of the opening 13a. The conductive elastic member 40 may be annularly formed to surround the whole outer peripheral edge of the vehicle roof panel 22. The conductive elastic member 40 may be formed to be divided for each linear edge part of the vehicle roof panel 22. The conductive elastic member 40 may be sandwiched between the inner peripheral edge of the opening 13a and the outer peripheral edge of the vehicle roof panel 22, thereby being held therebetween. A groove into which at least one of the inner peripheral edge of the opening 13a and the outer peripheral edge of the vehicle roof panel 22 is fitted may be formed in the conductive elastic member 40.

In the present embodiment, the conductive elastic member 40 is disposed between the inner peripheral edge of the opening 13a and the outer peripheral edge of the vehicle roof panel 22 in a plan view. In a case where the inner peripheral edge of the opening and the outer peripheral edge of the vehicle roof panel are overlapped with each other in the up-down direction, the conductive elastic member may be sandwiched between the inner peripheral edge of the opening and the outer peripheral edge of the vehicle roof panel in the up-down direction. In terms of preventing the radio wave leakage, the conductive clastic member 40 may be disposed to cover an approach route of the radio wave between the radio wave shielding part 30 and the opening 13a of the body 12. In terms of suppressing ingress of water, the conductive elastic member 40 may be disposed to closely contact the outer peripheral edge of the vehicle roof panel 22 and the inner peripheral edge of the opening 13a. It is also applicable that the conductive elastic member 40 is provided along a part of the outer peripheral edge of the vehicle roof panel 22, or the conductive elastic member 40 covers the outer peripheral edge of the vehicle roof panel 22 except for one or a plurality of partial positions in the outer peripheral edge of the vehicle roof panel 22 (such as a cutting part of the conductive elastic member 40, for example). In this case, a length of a part of the outer peripheral edge of the vehicle roof panel 22 other than the conductive elastic member 40 may be preferably set equal to or smaller than λ/8, and more preferably set equal to or smaller than λ/16 with respect to a wavelength λ of a frequency of the radio wave to be shielded. When there are a plurality of frequencies to be shielded, a minimum wavelength λ may be applied.

Accordingly, the radio wave is shielded by the conductive elastic member 40 between the body 12 and the vehicle roof panel 22. The conductive elastic member 40 intervenes between the body 12 and the vehicle roof panel 22, thus ingress of water running therebetween is suppressed.

In the present embodiment, the roof panel module 20 further includes the external antenna module 50. The external antenna module 50 includes the external antenna 53 for performing a wireless communication with an apparatus on the outer side of the vehicle. Herein, the external antenna module 50 includes a base substrate 52, the external antenna 53, and a case 54. The base substrate 52 is formed into a flat shape, that is, a quadrangular plate-like shape herein. A conductive layer 52a as a ground is formed by a metal foil, for example, on one main surface of the base substrate 52. The conductive layer 52a can serve a function of shielding the radio wave between both surfaces of the external antenna module 50. The external antenna 53 is provided on the base substrate 52. The external antenna 53 is an antenna for performing communication with a vehicle external apparatus, for example. The external antenna 53 is an antenna for performing communication with a wireless base station in a public communication line or a private communication line, an antenna for vehicle-and-vehicle communication or road-and-vehicle communication, or an antenna for receiving a GPS signal. One or the plurality of external antennas 53 may be provided on the base substrate 52. The case 54 is made up of resin, for example, and covers an upper side and lower side of the base substrate 52 and the external antenna 53 and four sides around the base substrate 52 and the external antenna 53. A bottom part of the case 54 protrudes to an outer side than the other part.

The antenna opening 22h formed in the vehicle roof panel 22 is formed into a shape corresponding to an outer periphery of the case 54. The external antenna module 50 is fitted into the antenna opening 22h from the vehicle interior side. Accordingly, even when the radio wave shielding part 30 is provided in the vehicle roof panel 22, the external antenna 53 is not covered by the radio wave shielding part 30 but can be directed to the outer side of the vehicle. The external antenna module 50 is formed into a thin box-like shape. The external antenna module may be formed into a fin-like shape or a rod-like shape. In this case, the external antenna module formed into the fin-like shape or the rod-like shape may be inserted into a hole formed in the vehicle roof panel to protrude to an outer side of the roof panel.

The conductive elastic member 45 is provided along the edge of the antenna opening 22h described above. That is to say, the conductive elastic member 45 is formed into an annular shape surrounding the whole periphery of the external antenna module 50, that is a quadrangular annular shape herein. The conductive elastic member may surround the whole periphery of the external antenna module 50 by a combination of a plurality of parts. Herein, the conductive elastic member 45 is sandwiched between the inner peripheral edge of the antenna opening 22h and the outer peripheral surface of the external antenna module 50, thereby being held therebetween. A groove into which at least one of the inner peripheral edge of the antenna opening 22h and the outer peripheral edge of the external antenna module 50 is fitted may be formed in the conductive elastic member 45. In the manner similar to the above description, it is also applicable that the conductive elastic member 45 is provided along a part of the periphery of the external antenna module 50, or the conductive elastic member 45 covers the periphery of the external antenna module 50 except for one or a plurality of partial positions in the periphery of the external antenna module 50 (such as a cutting part of the conductive elastic member 45, for example). In this case, a length of a part of the periphery of the external antenna module 50 other than the conductive elastic member 45 may be preferably set equal to or smaller than λ/8, and more preferably set equal to or smaller than λ/16 with respect to a wavelength λ of a frequency of the radio wave to be shielded. When there are a plurality of frequencies to be shielded, a minimum wavelength λ may be applied.

In the present embodiment, the conductive elastic member 45 is disposed between the inner peripheral edge of the antenna opening 22h and the outer peripheral surface of the external antenna module 50 in a plan view. In a case where the outer peripheral part of the external antenna module is overlapped with the inner peripheral edge of the antenna opening in the up-down direction, for example, the conductive elastic member may be sandwiched between the inner peripheral edge of the antenna opening and the outer peripheral part of the external antenna module in the up-down direction. In terms of preventing the radio wave leakage, the conductive elastic member 45 may be disposed to cover an approach route of the radio wave between the radio wave shielding part 30 and the external antenna module 50. In terms of suppressing ingress of water, the conductive elastic member 45 may be disposed to closely contact the inner peripheral edge of the antenna opening 22h of the vehicle roof panel 22 and the outer peripheral part of the external antenna module 50.

Accordingly, the radio wave is shielded by the conductive elastic member 45 between the body 12 and the external antenna module 50. The conductive elastic member 45 intervenes between the body 12 and the external antenna module 50, thus ingress of water running therebetween is suppressed.

The roof panel module 60 has a configuration similar to the roof panel module described above except that the antenna opening 22h and the external antenna module 50 are omitted.

The conductive elastic member 65 is provided along the whole peripheral edge of the roof panel module 60 while the roof panel module 60 is fitted into the opening 13b. The conductive elastic member 65 shields the radio wave and suppresses ingress of water between the opening 13b of the vehicle roof panel 22 and the roof panel module 60.

According to the roof panel module 20 having the above configuration, the radio wave shielding part 30 can shield the radio wave by the vehicle roof panel 22. Thus, the leakage of the radio wave from the inner side to the outer side of the vehicle and the ingress of radio wave from the outer side to the inner side of the vehicle are suppressed, and a communication environment in the vehicle is improved. The radio wave is shielded and a waterproof property is increased by the conductive elastic members 40 and 45 in the region near the edge of the vehicle roof panel 22.

When the radio wave shielding part 30 is the frequency selection part, the radio wave in a desired frequency band can pass through the roof panel modules 20 and 60, and the radio wave in the other desired frequency band can be shielded by the roof panel modules 20 and 60. Thus, a frequency band of radio wave used for communication between the inner side and the outer side of the vehicle is set so as not to be shielded by the radio wave shielding part 30, thus favorable communication can be performed between the inner side and outer side of the vehicle. A frequency band of radio wave used for in-vehicle communication or vehicle exterior communication is set to be shielded by the radio wave shielding part 30, thus the leakage of the radio wave can be suppressed on the inner side and the outer side of the vehicle.

In this case, even when the radio wave in all of the frequency bands is shielded by the conductive elastic members 40, 45, and 65, the radio wave in the frequency band not to be shielded by the radio wave shielding part 30 having a frequency selection property can pass therethrough, thus the favorable communication can be performed on the inner side and the outer side of the vehicle. The above configuration has a larger significance that the conductive elastic members 40, 45, and 65 can shield the radio wave used for the in-vehicle communication, for example.

When the conductive elastic member 45 described above is provided along the edge of the antenna opening 22h of the vehicle roof panel 22, the waterproof property is increased and the radio wave leakage is suppressed by the conductive elastic member 45 between the antenna opening 22h of the vehicle roof panel 22 and the external antenna module 50.

When the conductive elastic members 40 and 65 are provided along the outer peripheral edge of the vehicle roof panel 22, the waterproof property is increased and the radio wave leakage is suppressed in the region near the outer peripheral edge of the vehicle roof panel 22, that is, for example, between the vehicle roof panel 22 and the openings 13a and 13b into which the vehicle roof panel 22 is fitted.

### Embodiment 2

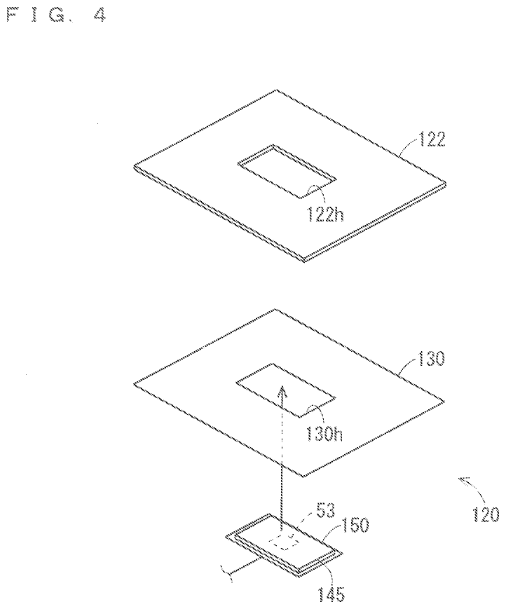

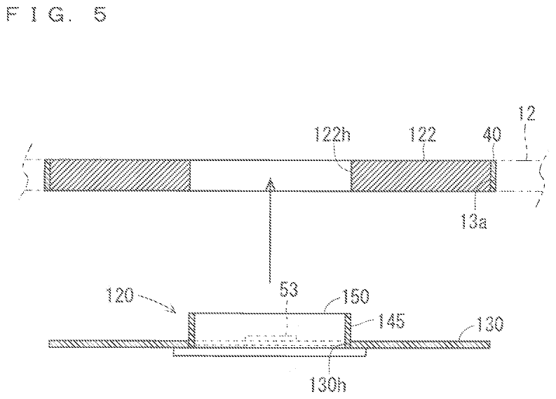

A roof module according to an embodiment 2 is described. FIG. 4 is an exploded perspective view illustrating a roof module 120. FIG. 5 is a cross-sectional view illustrating the roof module 120. FIG. 4 and FIG. 5 illustrate a vehicle roof panel 122 to which the roof module 120 is attached.

The roof module 120 is attached to the vehicle roof panel 122. The vehicle roof panel 122 is a constituent member similar to the vehicle roof panel 22 described above, and is formed by resin. An antenna opening 122h into which an external antenna module 150 is fitted is formed in the vehicle roof panel 122.

The roof module 120 includes a radio wave shielding part 130, the external antenna module 150, and a conductive elastic member 145.

The radio wave shielding part 130 has a configuration similar to the radio wave shielding part 30 described above. The external antenna module 150 has a configuration similar to the external antenna module 50 described above.

The radio wave shielding part 130 is preferably formed into a shape wholly extending to one main surface (a surface on a vehicle interior side) of the vehicle roof panel 122. An antenna opening 130h is formed in the radio wave shielding part 130. The antenna opening 130h is formed into a shape into which the external antenna module 150 can be fitted, that is a quadrangular opening shape herein. The external antenna module 150 is fitted into the antenna opening 130h. It is preferable that an outer peripheral part of the external antenna module 150 is fixed to an inner peripheral edge of the antenna opening 130h in the radio wave shielding part 130 while the external antenna module 150 is fitted into the antenna opening 130h. For example, a frame-like bracket is fixed by a screw to the outer peripheral part of the external antenna module 150. The inner peripheral edge of the antenna opening 130h in the radio wave shielding part 130 is sandwiched between the outer peripheral part of the external antenna module 150 and the bracket.

A sheet-like member (for example, a non-woven cloth) including a heat insulating layer and an acoustic layer may be overlapped with the radio wave shielding part 130. The other electrical apparatus or a wire harness, for example, may be incorporated into the radio wave shielding part 30.

The conductive elastic member 45 is a member having conductivity and elasticity in the manner similar to the conductive elastic members 40 and 45 described above. The conductive elastic member 145 is provided along the edge of the antenna opening 130h. Herein, the conductive elastic member 145 is formed into an annular shape externally fitted to the outer peripheral part of the external antenna module 150.

The conductive elastic member 145 closely contacts the outer peripheral surface of the external antenna module 150. Accordingly, in a case where there is a gap between the peripheral edge part of the antenna opening 130h of the radio wave shielding part 130 and the external antenna module 150, the conductive elastic member 145 is disposed to fill the gap. Accordingly, the radio wave leakage is suppressed between the external antenna module 150 and the radio wave shielding part 130.

The conductive elastic member 145 is exposed to an upper side of the radio wave shielding part 130. The conductive elastic member 145 is pressed against an inner peripheral part or a vehicle interior part of the antenna opening 122h in the vehicle roof panel 122 while the roof module 120 is attached to the vehicle roof panel 122. Accordingly, the conductive elastic member 145 prevents ingress of water between the vehicle roof panel 122 and the external antenna module 150.

The roof module 120 having such a configuration is attached to the vehicle roof panel 122. In this attachment state, the external antenna module 150 is fitted into the antenna opening 122h of the vehicle roof panel 122. The radio wave shielding part 130 is disposed along a surface on the vehicle interior side of the vehicle roof panel 122. The conductive elastic member 145 is disposed to cover an approach route of the radio wave between the radio wave shielding part 130 and the external antenna module 150. The conductive elastic member 145 intervenes between the vehicle roof panel 122 and the external antenna module 150. The conductive elastic member 145 closely contacts the inner peripheral edge of the antenna opening 122h of the vehicle roof panel 122 and the outer peripheral part of the external antenna module 150.

Thus, a function effect similar to that in the above embodiment 1 described above can be obtained. The roof module 120 has a configuration that the radio wave shielding part 130, the external antenna module 150, and the conductive elastic member 145 are integrally combined, thus the vehicle roof panel 122 can easily have a radio wave shielding function while incorporating the external antenna module 150.

Each configuration described in each embodiment and each modification example described above can be appropriately combined as long as they are not contradictory.

### EXPLANATION OF REFERENCE SIGNS

10 vehicle
12 body
12a reinforcement bar
13a opening
13b opening
20 roof panel module
22 vehicle roof panel
22h antenna opening
30 radio wave shielding part
40, 45 conductive elastic member
50 external antenna module
52 base substrate
52a conductive layer
53 external antenna
54 case
60 roof panel module
65 conductive elastic member
120 roof module
122 vehicle roof panel
122h antenna opening
130 radio wave shielding part
130h antenna opening
145 conductive elastic member
150 external antenna module

1. A roof panel module, comprising:
a vehicle roof panel formed of resin;
a radio wave shielding part provided in a corresponding region of the vehicle roof panel; and
a conductive elastic member having conductivity, wherein
the conductive elastic member is provided along at least a part of an edge of the vehicle roof panel.

2. The roof panel module according to claim 1, wherein
the radio wave shielding part is a frequency selection part having a selective radio wave shielding property with regard to a frequency band.

3. The roof panel module according to claim 1, further comprising
an external antenna module, wherein
the external antenna module is fitted into an opening formed in the vehicle roof panel, and
the conductive elastic member is provided along an edge of the opening.

4. The roof panel module according to claim 1, wherein
the conductive elastic member is provided along at least a part of an outer peripheral edge of the vehicle roof panel.

5. A roof module, comprising:
a radio wave shielding part provided in a corresponding region of a vehicle roof panel formed by resin;
an external antenna module; and
a conductive elastic member having conductivity, wherein
an opening is formed in the radio wave shielding part,
the external antenna module is fitted into the opening, and
the conductive elastic member is provided along an edge of the opening.
